(19) United States
(12) Patent Application Publication
(10) Pub. No.: US 2013/0264338 A1
(43) Pub. Date: Oct. 10, 2013

(54) Freight-Flat Safe

(71) Applicant: Brett DUNSTAN, Doveton (AU)

(72) Inventor: Brett DUNSTAN, Doveton (AU)

(73) Assignee: Lokaway Pty. Ltd, Doveton (AU)

(21) Appl. No.: 13/802,922

(22) Filed: Mar. 14, 2013

(30) Foreign Application Priority Data
Apr. 5, 2012 (AU) 2012901357

(51) Int. Cl. B65D 6/26; B23P 19/00

(52) U.S. Cl. CPC B65D 7/32; B23P 19/00
USPC 220/4.33; 29/525.01

(57) ABSTRACT

A knockdown safe or security box precursor is made of a flat base, side panels, end panels and a collar which together form a box. The sides and ends are joined together and to the base by fasteners which allow the box to be freighted as a stack of panels and components and then erected as a box by the use of fasteners which are only accessible from inside the box.

### FIELD OF THE INVENTION

This invention concerns security cabinets, safe storage deposit boxes, cash safes, gun safes, equipment and tool safes and security boxes for vehicles or working sites which are vulnerable at night and non-work days.

### BACKGROUND OF THE INVENTION

Safes are relied upon because they resist attempts to reach their contents. Such resistance requires special construction and special measures to withstand traditional modes of attack such as prying with levers. The rigid construction on which the safe relies however is a disadvantage when the safe is to be shipped. It cannot be reduced in volume. This invention addresses that disadvantage.

### SUMMARY OF THE INVENTION

One apparatus aspect provides a knockdown box being the lidless precursor of a safe, a toolbox or security box made of sheet metal components and panels including a base, a pair of ends, a pair of sides, which together form a box, a collar securable to the sides for lid attachment, wherein the sides and end are joined to each other and to the base and the collar is attached to the sides and ends by fasteners which allow the box to be freighted as a stack of panels and components and then erected as a box by the application of fasteners which are only accessible from inside the box.

Another apparatus aspect provides a knockdown safe or security box precursor in the form of a ready to assemble kit of parts which includes a base, sides and ends which are attachable to the base and a collar attachable to the sides and ends being capable of supporting a door or lid, the parts being made of sheet metal, the ends and sides at least having complementary, inter-engaging channels for stiffening the box, and fasteners which fasten the parts together and are locked and unlocked from inside the box.

A method aspect of the invention provides a method of assembling a knockdown box made of a base, sides, ends, and a collar, all made of sheet metal including the steps of connecting the sides and ends of the box to the base and to each other, connecting the collar to the sides and the ends by the insertion of ganged fasteners through the sheet metal and securing the fasteners from the inside of the box.

The ganged fasteners may have at least two threaded parallel fingers which extend from a carrier strip and are fixed to the strip so as to prevent rotation. The pins may be tubular or solid and the pins draw the strip into contact with the outer face or the sides and ends with which they are used.

If the carrier strip joins the fingers they cannot be rotated and they bridge the gap between two holes in the side or end acting as a clamp surface to force the superimposed sheets together. It is preferable if the strip extends the full height of the side or end using three or four fingers to clamp the parts together. The carrier strip may take the form of a channel with the floor of the channel excised at the sites of the fingers, the fingers being ordinary bolts, the heads of which sit in the excisions where they are each secured by a weld.

In a preferred form the base has upstands, the sides are bolted to the upstands and when the ends are fastened to base upstands the sides are connected to the ends by the inter-engagement of channels such that bores in the channels lie in register. The insertion of multiple fasteners on a common strip through the registered bores allows application of the fasteners and locking from inside the box. This renders the fasteners inaccessible from outside the box. Accordingly the opposite edges of the sides and ends are substantially S-shaped. The channels being super-imposable so as to stiffen the box, the carrier strips being at least partially accommodated in the cavity defined by the channels.

The collar may be secured by bolts more easily in that it is more accessible than the connections between the base and the sides/ends.

Thus an end may comprise a rectangular panel with the two upright edges bent to form channels, the lower edge between the channels being bent to form a 90E flange while the upper edge extends beyond channels. The collar may be bolted directly to the projecting upper edge.

### BRIEF DESCRIPTION OF THE DRAWINGS

One embodiment of the invention is now described with reference to the accompanying drawings, in which:

FIG. 1 is a perspective of a box with the lid attached.

FIG. 2 is a perspective of the box base.

FIG. 3 is a perspective of the exterior face of a box end.

FIG. 4 is a perspective of the interior face of a box end.

FIG. 5 is a perspective of a side and end suspended above the base with channels about to move into register.

FIG. 6 is a diagrammatic plan of the sides and ends ready to inter-engage to form the box on the base.

FIG. 7 is a section through a fragment of the corner of the box showing inter-engagement of channels.

FIG. 8 is a perspective of a fragment of the capping channel with ganged fasteners.

FIG. 9 is a perspective of the corner fragment of a side panel showing the surface on which the collar is seated.

FIG. 10 is a section of the top of a box end and the collar bolted thereto.

FIG. 11 is a section of the top of a side panel and the collar bolted thereto.

FIG. 12 is a perspective of the corner of the box where the handle is attached.

FIG. 13 is an exploded perspective of a gun safe made from parts which emerge from a flat pack.

### DETAILED DESCRIPTION WITH RESPECT TO THE DRAWINGS

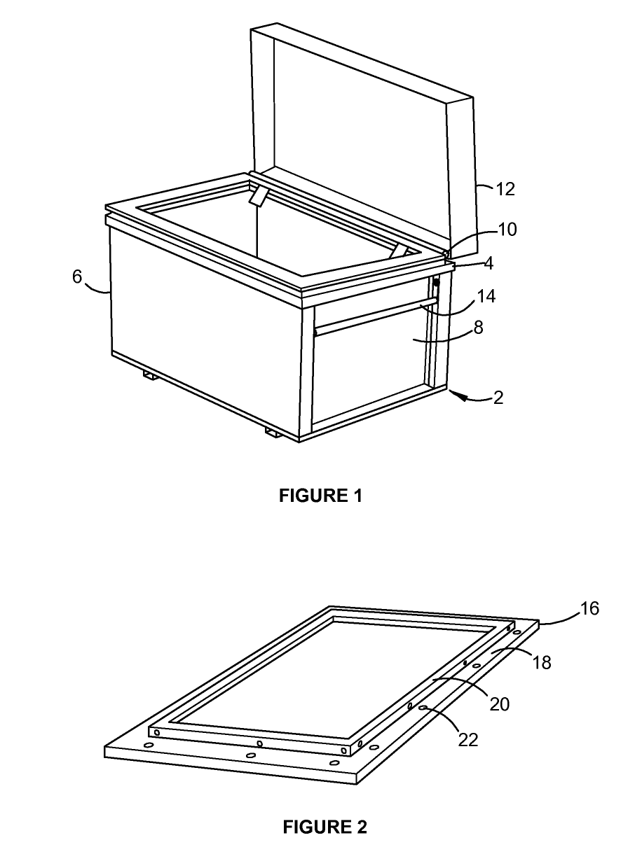

Referring now to FIGS. 1-5, the box 2 has a collar 4 bolted to the sides 6 and ends 8. The collar has a full length hinge 10 connecting the lid 12 to the collar 4. A folding bar handle 14 allows the box to be dragged or lifted when locked. The lid and collar are suitable for connection by a swing and slide hinge as described in our co-pending Application Nos. 2009903569, 2008904566 and 2009902825.

The components including base 16 are made from 1.3 mm sheet steel. The base is rectangular with a raised margin 18 terminating in an L-section upstand 20. Both have bolt holes 22.

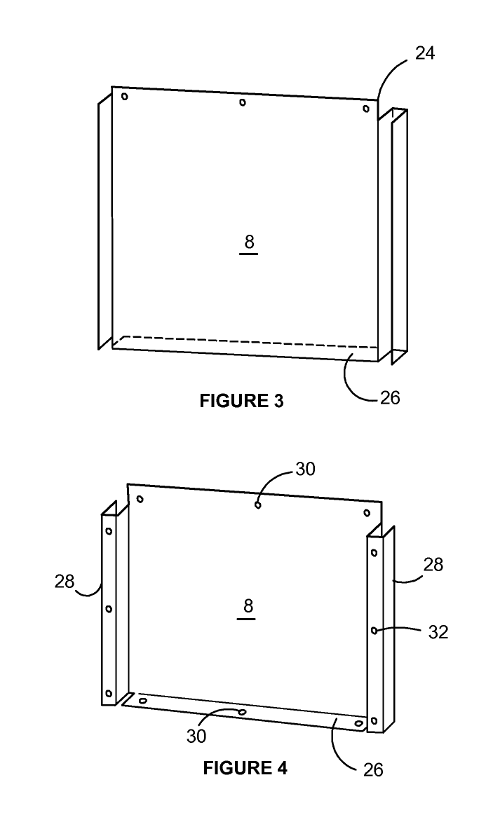

FIGS. 3 and 4 each show end 8 having a collar extension 24 at its top edge and a base flange 26 at its bottom edge for sitting on raised margin 18 between upright channels 28. Both have boltholes 30, 32.

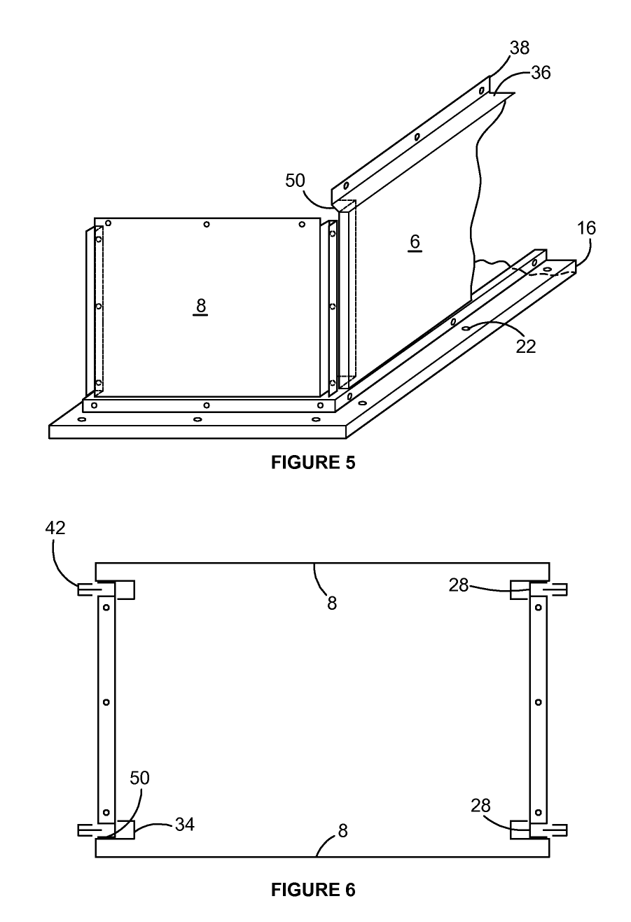

In FIGS. 5 and 6, side 6 has upright channels 34 in the plane of the component in order to receive the corresponding nesting channels 28. The top of each side has an inturned collar seat 36 and an upstand 38. Channels 32 are somewhat wider than channels 28 and give a running fit. Bolt holes 32 register with bolt holes 40 in the channels 34 enabling the sides and ends to be bolted together by capping channels 42 shown in FIGS. 6, 7 and 8. Ganged fasteners 44 are used for the channels because the nested channels face outside the box.

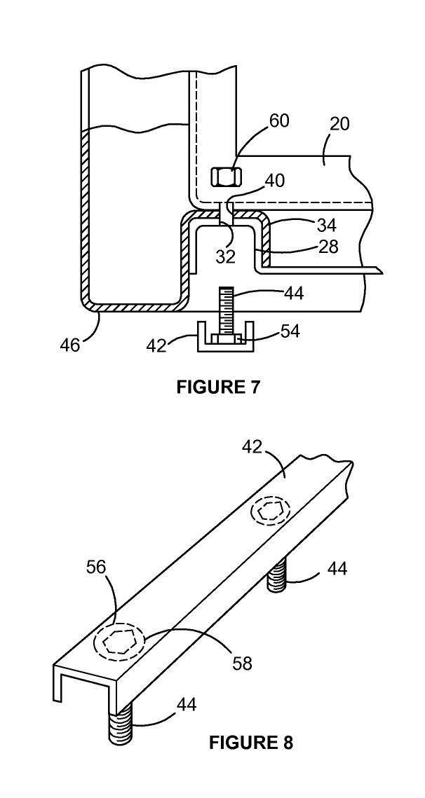

In FIGS. 6 and 7 the corners 46 of the sides are of substantially S-section and this stiffens the corners. The bottom edge of the side 8 has a base flange 48 which sits on the margin 18 of the base and receives bolts (not shown) introduced into the space beneath the margin and then through the base flange 48. In FIG. 8 capping channel 42 is bored at the sites of the boltholes in the box channels. The hexagon 54 head of a bolt 44 is a push fit in the bore 56. When the head is flush with the channel face a ring of welding metal 58 is deposited arresting the bolt in the capping channel 42. The latter occupies most of the volume in the channels 28 which face outwards and the bolts protrude on the inside of the box allowing capture by nuts 60.

The collar 4 is also S-shaped in section and connected to the side upstands 38 and the end upstands 24 by bolts inserted and screwed up from the inside during assembly.

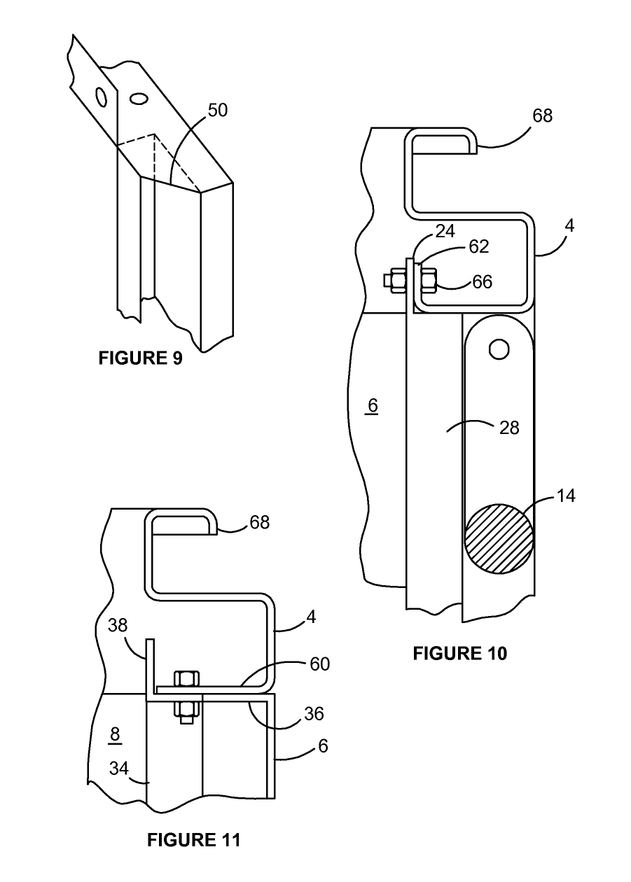

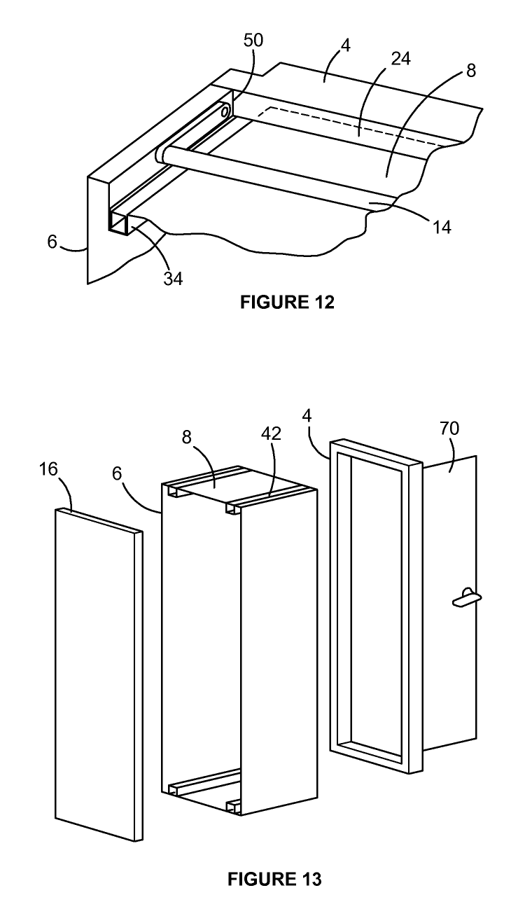

FIG. 9 shows the S-conformation which forms channel 34 and is overlaid by seat 36. Upstand 38 does not extend to the ends of the panel. Instead flange 36 is cut at 45E to form edge 50.

Whereas a box collar as shown in FIG. 1 is useful, the collar profile of FIGS. 10-12 is preferred. The two sides of the collar which sit on the side seats 36 have inturned horizontal margins 60. The two ends of the collar which span the ends 8 of the box have inturned margins also and a collar upstand 62 which attaches to collar extension 24 by fasteners 66. The entire collar 4 has an outwardly extending lip 68.

The nesting of channels and the shape of the base results in high stiffness and resistance to deformation for a sheet steel structure. The design of the upstands and margins resists water entry and it is possible to waterproof the product by sealing with a silicone cartridge and gun.

In FIG. 13, an elongated gun safe is made in flat pack form by constructing the back of the safe as base 16. To the base are bolted the ends 8 and sides 6 as described in the previous figures, whereafter a collar 4 with the swing and slide door 70 instead of lid 12 is bolted to the box built from the ends and sides. The channels are occupied by capping channels 42.

We have found the advantages of the above embodiment to be:

1. The box increases packing density.

2. The safety of the construction is preserved.

3. The benefits 1. and 2. pertain to boxes with or without swing and slide lids.

4. The construction is applicable to gun safes.

5. Resists water entry onsite.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

What is claimed is:

1. A knockdown box being a lidless precursor of a safe, a toolbox or security box made of sheet metal components and panels including a base, a pair of ends, a pair of sides which together form a box, a collar securable to the sides for lid attachment, wherein the side and ends are joined to each other and to the base and the collar is attached to the sides and ends by fasteners which allow the box to be freighted as a stack of panels and components and then erected as a box by the application of fasteners which are only accessible from inside the box.

2. A knockdown lidless precursor of a safe as claimed in claim 1, wherein the sides each have a pair of edge channels, the ends each have a pair of edge channels, the channels have bores so that when the edge channels of the ends inter-engage with the edge channels of the sides, the bores mutually register.

3. A knockdown lidless precursor of a safe as claimed in claim 1, wherein the bores which lie in register in each pair of inter-engaged channels receive fasteners which project from a linear ganged connector, whereby ganged fasteners project into the bores in order to be lockable and unlockable from inside the box.

4. A knockdown lidless precursor of a safe as claimed in claim 2, wherein the opposite edges of the side panels and end panels, both have pairs of opposite edges, each of which forms a channel which is substantially S-shaped in section.

5. A knockdown lidless precursor of a safe as claimed in claim 3, wherein the ganged connector is a strip or channel with threaded bolts extending from the strip or channel in a common direction, the bolt heads being welded to the strip or channel.

6. A knockdown lidless precursor of a safe as claimed in claim 2, wherein the ends are rectangular with an upper edge, a lower edge and two upright edges formed as channels, the lower edge between the channels being bent to form a 90 degree flange while the upper edge extends beyond the channels and has bores for the attachment of the collar.

7. A knockdown lidless precursor of a safe as claimed in claim 6, wherein the side is a panel with a top perimeter formed by a horizontal inwardly disposed collar bed and a collar upstand projecting from the inward edge of the bed.

8. A knockdown lidless precursor of a safe as claimed in claim 1, wherein the collar is a frame component of S-section with bores for attachment to the ends and sides which are accessible only from inside the box.

9. A knockdown lidless precursor of a safe as claimed in claim 4, wherein the two ends each have a swing out handle for lifting or dragging the box.

10. A knockdown lidless precursor of a safe as claimed in claim 1, wherein the base has a raised margin which terminates in an L-section upstand.

11. A knockdown safe or security box precursor in the form of a ready to assemble kit of parts which consists of a box, sides and ends which are attachable to the box base, a collar attachable to the sides and ends being capable of supporting a door or lid, the parts being made of sheet metal, the ends and sides at least having complementary, inter-engaging channels for stiffening the box and fasteners which fasten the parts together which fasteners are locked and unlocked from inside the box.

12. A method of assembling a knockdown security box made of a base, sides, ends and a collar, all made of sheet metal including the steps of connecting the sides and ends of the box to the box base and to each other by insertion of ganged fasteners through the sheet metal securing the ganged fasteners from inside the box and securing the collar to the sides and ends by fasteners applied from inside the box.
